(19) United States
(12) Patent Application Publication
(10) Pub. No.: US 2004/0004639 A1
(43) Pub. Date: Jan. 8, 2004

(54) Your color combination by number

(76) Inventor: Donna Lee Simonis, Oconomowoc, WI (US)

Correspondence Address: DONNA LEE SIMONIS, 3909 W. BEACH RD., OCONOMOWOC, WI, 53066, US

(21) Appl. No.: 10/187,770

(22) Filed: Jul. 3, 2002

(51) Int. Cl. G09G 5/00

(52) U.S. Cl. 345/810

(57) ABSTRACT

What is considered new technology with this invention is the ability to view the color combination selected prior to completing the home improvement task. Many colors look good together when paint samples are laid side by side, however once large sections of a home are painted, the customer may not like the effect. This can cause duress and additional expense if the home needs to be repainted to satisfy a customer.

### CROSS-REFERENCE TO RELATED APPLICATION

Not Applicable

### STATEMENT REGARDING FEDERALLY SPONSORED RESEARCH OR DEV

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

Decorating Color Selection Software

### BRIEF SUMMARY OF THE INVENTION

The invention is software that allows an individual to view how an outdoor home improvement project will look with preselected colors for painting various parts of the house. The software color selection gives the individual a view of the finished product before the job is actually done. The software includes four house outlines, including ranch, Cape Cod, Victorian and salt box. A second option would be to scan a photo of user's actual house, remove color and shading, to begin same process with color fill. A color palette is programmed with the color numbers of individual paint manufacturers. The user selects a paint number from the sample paint strips of a paint manufacturer and then clicks on the portion of the house outline to be painted that color.

### BRIEF DESCRIPTION OF THE SEVERAL VIEWS OF THE DRAWING

Not Applicable

### DRAWINGS

“Your Color Combination By Number⇄ Invented by Donna L. Laughlin The following view represents a computer screen at a retail location where paint is sold. This is after the house type is selected.

[image]

### DETAILED DESCRIPTION OF THE INVENTION

The software will ask the user to select one of four styles of home. The four styles are

1) Ranch

2) Cape Cod

3) Victorian

4) salt box.

Once selected, the screen will fill with an outline of the house. The areas to fill with color will be sectioned as follows

1) Base

2) Trim including large outside window trim

3) Inside window trim

4) Shutters

5) Door

When the user inserts the color number in one of the 5 areas above, the corresponding section of the house outline will fill with the color selected. When all 5 sections are selected, the user would see how the colors they picked look together prior to painting their house, thus eliminating possible repainting. If a scan is created of the user's actual house, a click and fill option will be available.

1. What I claim as my invention is the ability to provide to a customer or user, a view of their style home in colors selected from a paint manufacturers sample strip, with computer software providing the image. The computer software would need color programming from the manufacture. This to be pursued by myself, Donna L. Laughlin, once patent is obtained.
